(19) United States
(12) Patent Application Publication
(10) Pub. No.: US 2025/0103866 A1
(43) Pub. Date: Mar. 27, 2025

(54) FIDELITY-BASED EXPLANABILITY FOR GNNS

(71) Applicant: NEC Laboratories America, Inc., Princeton, NJ (US)

(72) Inventors: Wei Cheng, Princeton Junction, NJ (US); Haifeng Chen, West Windsor, NJ (US); Dongsheng Luo, State College, PA (US)

(21) Appl. No.: 18/890,888

(22) Filed: Sep. 20, 2024

Related U.S. Application Data
(60) Provisional application No. 63/539,626, filed on Sep. 21, 2023.

(51) Int. Cl. G06N 3/047

(52) U.S. Cl. CPC G06N 3/047

(57) ABSTRACT

Methods and systems include processing an input graph using a graph neural network (GNN) to generate an output. An explanation sub-graph is generated using an explainer that identifies parts of the input graph that most influence the output. A fidelity measure of the explanation sub-graph is determined that is robust against distribution shifts. An action is performed responsive to the output, the explanation sub-graph, and the fidelity measure.

### RELATED APPLICATION INFORMATION

This application claims priority to U.S. Patent Application No. 63/539,626, filed on Sep. 21, 2023, incorporated herein by reference in its entirety.

### BACKGROUND

### Technical Field

The present invention relates to machine learning models and, more particularly, to graph neural networks.

### Description of the Related Art

Graph neural networks (GNNs) are a type of machine learning model that handles data in the form of graphs. GNNs can be used to extract information from data having graph structures. For example, message passing may be used to update node representations by aggregating messages from their neighbors, which makes it possible for the GNN to capture both node features and topology information. GNNs can be used for a variety of tasks, such as node classification, graph classification, and link prediction. Exemplary applications include drug discovery, recommender mechanisms, fraud detection, and social networking.

### SUMMARY

A method includes processing an input graph using a graph neural network (GNN) to generate an output. An explanation sub-graph is generated using an explainer that identifies parts of the input graph that most influence the output. A fidelity measure of the explanation sub-graph is determined that is robust against distribution shifts. An action is performed responsive to the output, the explanation sub-graph, and the fidelity measure.

A system includes a hardware processor and a memory that stores a computer program. When executed by the hardware processor, the computer program causes the hardware processor to process an input graph using a graph neural network (GNN) to generate an output, to generate an explanation sub-graph using an explainer that identifies parts of the input graph that most influence the output, to determine a fidelity measure of the explanation sub-graph that is robust against distribution shifts, and to perform an action responsive to the output, the explanation sub-graph, and the fidelity measure.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing the explanation of a graph neural network (GNN) output using a fidelity measure, in accordance with an embodiment of the present invention;

FIG. 2 is a block/flow diagram showing the selection of a fidelity measure, in accordance with an embodiment of the present invention;

FIG. 3 is a block/flow diagram of a method for performing a GNN task with explanations that are evaluated by a fidelity measure, in accordance with an embodiment of the present invention;

FIG. 4 is a block diagram of a computing device that can explain a GNN output using a fidelity measure, in accordance with an embodiment of the present invention;

FIG. 5 is a diagram of an exemplary neural network architecture that can be used as part of an explainer model, in accordance with an embodiment of the present invention; and

FIG. 6 is a diagram of an exemplary deep neural network architecture that can be used as part of an explainer model, in accordance with an embodiment of the present invention.

### DETAILED DESCRIPTION OF PREFERRED EMBODIMENTS

While graph neural networks (GNNs) are powerful tools, it can be challenging to interpret their outputs. Understanding how GNNs arrive at their outputs fosters greater confidence in applying GNNs in areas where errors have serious consequences. Furthermore, explainability heightens the transparency of GNNs, making them more appropriate for use in delicate sectors, such as healthcare and pharmaceutical development, where fairness, privacy, and safety are high priorities.

Unbiased fidelity measurements can be used to evaluate the faithfulness of an explanation for a GNN's output. The model f may be implemented as a black box, which cannot be fine-tuned to generalize it. Additionally, evaluation may be stable and, ideally, deterministic. As a result, complex parametric evaluation metrics may not be well suited to explainability, as the results may be affected by randomly initiated parameters.

The explanation task is therefore formulated to generate a sub-graph which closely matches the statistics of the original graph with respect to the output of the GNN. That is, the GNN is likely to generate a similar output when given the original graph or the sub-graph. This sub-graph is then used as a tool for explaining the parts of the original graph which were significant to arriving at the output.

A generalized class of surrogate fidelity measures are described herein which are robust to distributional shifts in a wide range of scenarios. These metrics can be used to implement the explainer to ensure that a given sub-graph is close to the original graph in its treatment by the GNN.

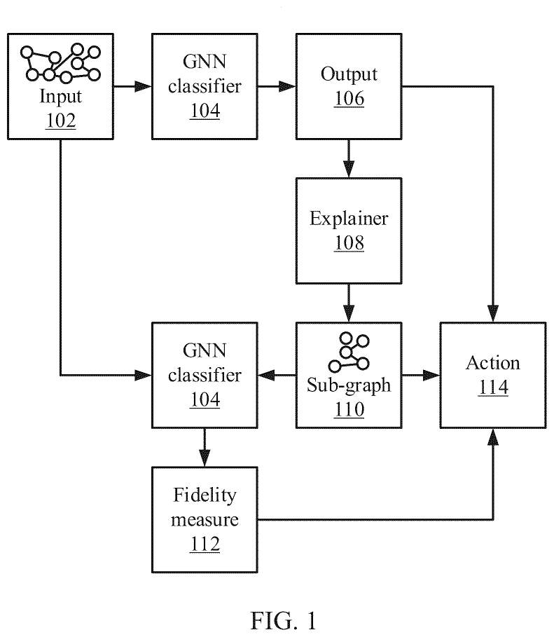

Referring now to FIG. 1, GNN explanation is shown. An input 102 is provided that includes a graph, made up of nodes and edges connecting the nodes. The input 102 may include any appropriate type of information, where the nodes represent entities of an arbitrary type and the edges represent edges between those entities. In one example, the input 102 may include a representation of a complex molecule, with the nodes representing atoms and with the edges representing bonds between the atoms. In another example, the input 102 may represent a computer network, with the nodes representing computer systems and with edges representing connections between the computer systems.

A GNN classifier 104 is used to process the input 102. The GNN classifier may, for example, extract some property of the input 102 such as a molecule's affinity for binding to a particular biological receptor. In another example, the GNN classifier 104 may identify whether an attacker has intruded into a computer network or may indicate a network failure. Although a classifier is specifically contemplated, it should be understood that the GNN classifier 104 may be replaced by any appropriate GNN. The output 106 of the GNN classifier 104 may thus be a vector that includes a classification result or any other output appropriate to the task for which the GNN has been trained. The GNN classifier 104 may be regarded herein as a black box, without any ability to train or tune its parameters during operation.

The output 106 is used as the basis for some action 114. For example, the action 114 may include correction to a network failure. However, the action 114 may need information beyond the output 106 to effect a solution. The bare output 106 may not include an explanation for why the GNN classifier 104 indicated, for example, a network failure.

An explainer 108 is thus used to identify a sub-graph 110 of the input 102 that is most relevant to the output 106. For example, this sub-graph may identify systems within the computer network and connections between them that are most indicative of a network failure indicated by the output 106. The action 114 can use this sub-graph to direct its corrective intervention.

However, some assurance of the correctness of the explanation would also be helpful. To that end, the sub-graph 110 is fed back into the GNN classifier 104 and its output is compared to the output resulting from the input 102. A fidelity measure 112 is used to determine how similar the output 106 is to the output generated by the sub-graph 110. The closer these two outputs are, according to the fidelity measure 112, the more likely the sub-graph 110 is to be an accurate explanation of the action of the GNN classifier 104. A good fidelity score indicates that the portions of the input 102 that are excluded from the sub-graph 110 have little impact on the output 106.

The explainer 108 may be implemented by any appropriate mechanism. Regardless of the mechanism selected, the trustworthiness of the sub-graph 110 that it generates depends on the reliability of the fidelity measure. While quantitative evaluation of a sub-graph 110 can be performed by comparing it to a ground truth explanation, such known-true ground truth examples are rare in real-world applications. A first fidelity measure, Fid₊, is defined as the difference in accuracy (or predicted probability) between outputs generated by the output 106 and an output based on a remainder of the input 102 when the sub-graph 110 is removed. A second fidelity measure, Fid₋, measures the difference the output 106 and an output based on the sub-graph 110. However, these fidelity measures have drawbacks due to an assumption that the to-be-explained model can make accurate predictions based on the sub-graph 110 or remainder sub-graph. This assumption does not hold in a wide range of real-world scenarios because, when edges are removed, the resulting sub-graphs may be out of distribution.

For example, in an input 102 that includes a molecule with nodes representing atoms and edges describing the chemical bonds, the functional group NO₂ may be considered a dominant sub-graph that causes the molecule to be mutagenic. This explanation sub-graph includes only two edges, which may be much smaller than the whole molecular graph. Such disparities in properties introduce distribution shifts, reducing the reliability of the fidelity measures described above. Machine learning relies on training and test data coming from the same distribution, so a sub-graph that is out of the distribution will produce unreliable results.

A labeled graph G may be represented as a tuple (V, ε; Y, X, A), where i) V={v₁, v₂, . . . , vₙ} is the vertex set, ii) ε⊆V×V is the edge set, iii) Y is the graph class label taking values from finite set of classes [symbol] , iv) X∈ [symbol] ^{n×d} is the feature matrix, where the i^{th} row of X, denoted by Xᵢ∈ [symbol] ^{1×d}, is the d-dimensional feature vector associated with node vᵢ, i∈[n], and v) A∈{0,1}^{n×m} is the adjacency matrix. The graph parameters (Y, A, X) are generated according to the joint probability measure P_{Y,A,X}. Note that the adjacency matrix determines the edge set ε, where Aᵢⱼ=1 if (vᵢ, vⱼ)∈ε, and Aᵢⱼ=0, otherwise. The terms |G| and |ε| are used interchangeably to denote the number of edges of G. Lower-case letters, such as g, y, x, and a, are used to represent realizations of the random objects G, Y, X and A, respectively.

Given a labeled graph G=(V, ε; Y, X, A), the corresponding graph without label is written as as G̅, and is parameterized by (V, ε; X, A). The induced distribution of G̅ is represented as [symbol] , and its support is [symbol] .

In a classification task, there may be a set of labeled training data [symbol] ={(G̅ᵢ, Yᵢ)|Yᵢ∈ [symbol] , i∈[| [symbol] |]}, where (G̅ᵢ, Yᵢ) corresponds to the i-th graph and its associated class label. The pairs (G̅ᵢ, Yᵢ), i∈[| [symbol] |] are generated independently according to an identical joint distribution induced by P_{Y,X,A}. A classification function (GNN classifier 104) ƒ(·) is trained to classify an unlabeled input graph G̅ into its class Y. It takes G̅ as input and outputs a probability distribution P_{Y} on alphabet [symbol] . The reconstructed label Ý is produced randomly based on P_{Y}.

In node classification tasks, each graph Gᵢ denotes a K-hop sub-graph centered around node vᵢ, with a GNN model ƒ trained to predict the label for node vᵢ based on the node representation of vᵢ learned from Gᵢ, whereas in graph classification tasks, Gᵢ is a random graph whose distribution is determined by the (general) joint distribution P_{Y,A,Z}, with the GNN model ƒ(·) trained to predict the label for graph G based on the learned representation of G̅.

For a classification task with underlying distribution P_{Y,X,Λ}, a classifier is a function ƒ: [symbol] →Δy. For a given ϵ>0, the classifier is called ϵ-accurate if P(Ý≠Y)≤ϵ, where Ý is produced according to probability distribution ƒ(G̅).

There are two types of explainability to consider: Explainability of a classification task and explainability of a classifier for a given task. Given a classification task with underlying distribution R_{Y,X,A}, an explanation function for the task is a mapping Ψ: G̅ [symbol] (Vₑₓₚ, εₑₓₚ) which takes an unlabeled graph G̅=(V, ε; X, A) as input and outputs a subset of nodes V_{cxp}⊆V and subset of edges εₑₓₚ⊆V_{cxp}×Vₑₓₚ. Loosely speaking, a good explanation (Vₑₓₚ, εₑₓₚ) is a subgraph which is an (almost) sufficient statistic of G̅ with respect to the true label Y, i.e., I(Y; G̅| [symbol] )≈0. The term d² may be expressed with:

$$I ( Y ; \overline{G} \vert {1}_{Ψ ( G )} ) {=}^{△} {\sum }_{{g}_{exp}} {P}_{Ψ ( \overline{G} )} ( {g}_{exp} ) {\sum }_{y , \overline{g}} {P}_{Y , \overline{G}} ( y , \overline{g} \vert {g}_{exp} ⊆ \overline{G} ) log \frac{{P}_{Y , \overline{G}} ( y , \overline{g} \vert {g}_{exp} ⊆ \overline{G} )}{{P}_{Y} ( y \vert {g}_{e x p} ⊆ \overline{G} ) {P}_{\overline{G}} ( \overline{g} \vert {g}_{e x p} ⊆ \overline{G} )}$$

In practice, an explanation function may be selected to have an output size that is significantly smaller than the original input size, i.e., E_{G}(|Ψ(G̅)|)« [symbol] _{G}(|G̅|).

A classification task may have an underlying distribution P_{Y,X,A}. An explanation function for this task is a mapping Ψ: [symbol] →2^{V}×2^{ε}. For a given pair of parameters κ∈[0,1] and s∈ [symbol] , the task is called (s, κ)-explainable if there exists an explanation function Ψ: G̅ [symbol] (Vₑₓₚ, εₑₓₚ) such that: i I(Y; G̅| [symbol] )≤κ and ii) E_{G}(|εₑₓₚ|)≤s.

A similar notion of explainability can be provided for a given classifier as follows. A classification task may have an underlying distribution P_{Y,X,A} and a classifier ƒ: [symbol] →Δy. For a given pair of parameters ζ∈[0,1] and s∈ [symbol] , the classifier ƒ(·) is called (s, ζ)-explainable if there exists an explanation function Ψ(·) such that: i) I(Ý; G̅| [symbol] )≤ζ and ii) [symbol] _{G}(|εₑₓₚ|)≤s, where Ψ(G̅)=(Vₑₓₚ, εₑₓₚ) and Ý is generated according to the probability distribution ƒ(G̅). The explanation function Ψ(·) is called an (s, ζ) explanation for ƒ(·). I(Y; G̅| [symbol] ) can be alternatively written as [symbol] (I(Y; G̅|Ψ(G̅′)⊆G̅)), where

$${P}_{\overline{{YGG}^{′}}} = {P}_{Y \overline{G}} {P}_{{\overline{G}}^{′}} .$$

The explainability of the classification task does not imply, nor is it implied by, the explainability of a classifier for that task. For example, the trivial classifier whose output is independent of the input is explainable for any task, even if the task is not explainable itself. To keep the analysis tractable, a condition may be imposed on Ψ(·):

$$∀ \overline{g} , {\overline{g}}^{′} : Ψ ( \overline{g} ) ⊆ {\overline{g}}^{′} ⇒ Ψ ( {\overline{g}}^{′} ) = Ψ ( \overline{g} )$$

This condition holds for the ground-truth explanation in many of the widely studied datasets in the explainability literature such as BA-2motifs, Tree-Cycles, Tree-Grid, and MUTAG datasets. A consequence of the condition is that, if Ψ(·) satisfies the condition, then I(Ý; G̅|1_{Ψ(G)})=I(Ý; G̅|Ψ(G̅)). If the classifier has a low error probability, assuming this condition, then its explainability implies the explainability of the underlying task. Conversely, if the task is explainable, and its associated Bayes error rate is small, then any classifier for the task with an error close to the Bayes error rate is explainable.

For a classification task with underlying distribution P_{Y,X,A}, parameters ζ, κ, ϵ∈[0,1], and an integer s∈ [symbol] , if there exists a classifier ƒ(·) for this task which is ϵ-accurate and (s, ζ)-explainable, with the explanation function satisfying the above condition, then, the task is (s, κ′)-explainable, where

$${κ}^{′} \leq ζ + {h}_{b} ( ϵ ) + ϵ log ( \vert 𝓎 \vert - 1 )$$

and h_{b}(p) [symbol] −p log p−(1−p)log 1−p, p∈[0,1] denotes the binary entropy function. Particularly, κ′→0 as ζ, ϵ→0. If the classification task is binary (i.e. [ [symbol] ]=2), it is (s, κ)-explainable with an explanation function satisfying the condition, and has Bayes error rate equal to ϵ*, then any (ϵ*+δ)-accurate classifier h(·) is (s, η)-explainable, where

$$η {=}^{△} {h}_{b} ( τ ) + τ , τ {=}^{△} \frac{{( 2 \sqrt{2} {ϵ}^{*} + \sqrt{ξ} )}^{2}}{2} , ξ {=}^{△} δ + {e}_{max} ( {ϵ}^{*} , κ ) - {ϵ}^{*} , δ ∈ ( 0 , 9 {ϵ}^{*} - {e}_{max} ( {ϵ}^{*} , κ ) ) ,$$

where eₘₐₓ(·) is defined below. Particularly, η→0 as δ, ϵ*, κ→0.

For a classification task with underlying distribution P_{Y,X,Λ}, parameters κ, ϵ∈[0,1], and an integer s∈ [symbol] , assuming that the task is (s, κ)-explainable with an explanation function satisfying the above condition, and further assuming that the classification task has a Bayes error rate equal to ϵ*, then there exists an e-accurate and (s, 0)-explainable classifier ƒ(·), such that

$$ϵ \leq {e}_{max} ( {ϵ}^{*} , κ )$$

$$where$$

$${e}_{R F} ( z ) {=}^{△} ( 1 - ( 1 - z ) ⌊ \frac{1}{1 - z} ⌋ ) ( 1 + ⌊ \frac{1}{1 - z} ⌋ ) ln ( 1 + ⌊ \frac{1}{1 - z} ⌋ ) - ( z - ( 1 - z ) ⌊ \frac{1}{1 - z} ⌋ ) ⌊ \frac{1}{1 - z} ⌋ ln ⌊ \frac{1}{1 - z} ⌋ , z ∈ ( 0 , 1 ) .$$

In particular, ϵ→0 as ϵ*, κ→0.

The above provides intuitive notions of explainability along with fidelity measures expressed as mutual information terms. However, in most practical applications it is not possible to quantitatively compute and analyze them. Estimating the mutual information term, I(Ý; G̅| [symbol] ) is not practically feasible in most applications since G̅ has large alphabet size. At a high level, an ideal surrogate measure Fid*: (ƒ, Ψ) [symbol] [symbol] ^{≥}^{⁰} should satisfy two properties: i) The surrogate fidelity value Fid*(ƒ, Ψ) should be monotonic with the mutual information term I(Ý; G̅| [symbol] ), so that a ‘good’ explanation function with respect to the surrogate fidelity measure is ‘good’ under the mutual information and vice versa, and ii) there must exist an empirical estimate of Fid*(ƒ, Ψ) with sufficiently fast convergence guarantees so that the surrogate measure can be estimated accurately using a reasonably large set of observations.

For a classification task with underlying distribution P_{Y,X,A} a (surrogate) fidelity measure is a mapping Fid: (ƒ, Ψ)→ [symbol] ^{≥0}, which takes a pair consisting of a classification function ƒ(·) and explanation function Ψ(·) as input, and outputs a non-negative number. The fidelity measure is said to be well-behaved for a set of classifiers [symbol] and explanation functions [symbol] if for all pairs of explanation functions Ψ₁, Ψ₂∈ [symbol] and classifiers ƒ∈ [symbol] , we have:

$$I ( \hat{Y} ; \overline{G} \vert {1}_{{Ψ}_{1} ( G )} ) \leq I ( \hat{Y} ; \overline{G} {\vert}_{{Ψ}_{2} ( \overline{G} )} ) ⇔ Fid ( f , {Ψ}_{2} ) \leq F i d ( f , {Ψ}_{1} )$$

This fidelity condition requires that better explanation functions must have higher fidelity when evaluated using the surrogate measure.

Let [symbol] ={(G̅ⱼ, Yⱼ)|j≤i}, i∈ [symbol] be a sequence of sets of independent and identically distributed observations for a given classification problem. A fidelity measure Fid(·,·) is said to be empirically estimated with rate of convergence β if there exits a sequence of functions Hₙ: [symbol] [symbol] [symbol] , n∈ [symbol] such that for all ϵ>0, we have:

$$P ( \vert F i d ( f , Ψ ) - {\hat{Fid}}_{n} ( f , Ψ ) \text{\textbar >} ϵ ) = 0 ( {n}^{- β} )$$

for all classifiers ƒ and explanation functions Ψ.

As discussed above, some fidelity measures may be expressed as:

$$F i {d}_{+} {=}^{△} 𝔼 ( \hat{P} ( Y ) - {\hat{P}}^{+} ( Y ) )$$

$$Fi {d}_{-} {=}^{△} 𝔼 ( \hat{P} ( Y ) - {\hat{P}}^{-} ( Y ) )$$

$${Fid}_{Δ} {=}^{△} {F}^{′} {d}_{+} - Fi {d}_{-} ,$$

where \acute{P}(·) is the distribution given by ƒ(G̅), \acute{P}⁺(·) is the distribution given by ƒ(G̅ᵢ−Ψ(G̅ᵢ)), \acute{P}⁻(·) is the distribution given by ƒ(Ψ(G̅ᵢ)), G̅−Ψ(G̅) is the subgraph with edge set ε−εₑₓₚ for Ψ(G̅)=(Vₑₓₚ, εₑₓₚ), and [symbol] is a set of independent observations [symbol] ={(G̅ᵢ, Yᵢ), i=1,2, . . . , | [symbol] |} These fidelity measures can be empirically estimated by

$${=}^{△} \frac{1}{\vert \vert} {\sum }_{i = 1}^{\vert \vert} \hat{P} ( {y}_{i} ) - {\hat{P}}^{+} ( {y}_{i} )$$

$${-}_{} {=}^{△} \frac{1}{\vert \vert} {\sum }_{i = 1}^{\vert \vert} \hat{P} ( {y}_{i} ) - {\hat{P}}^{-} ( {y}_{i} )$$

$$= {=}^{△} - {-}_{} .$$

The rate of convergence of this empirical estimate is

$$β = \frac{1}{2} ( e . g . , using the Berry - Esseen theorem ) .$$

These measures are well-behaved for a class of deterministic classification tasks and completely explainable classifiers.

For a deterministic classification task, for which the induced distribution P_{G} has support [symbol] consisting of all graphs with n∈ [symbol] vertices, the graph edges may be jointly independent, and X∈ [symbol] ^{n×d}, where [symbol] is a finite set. The graph label may be assumed to be Y=1(g_{cexp}⊆G̅) for a fixed subgraph gₑₓₚ, so that the task is deterministic. Let ƒ(G̅)=1(g_{cxp}⊆G̅) be the 0-correct classifier. Let [symbol] ={Ψₚ(g̅|p∈[0,1]} be a class of explanation functions, where P(Ψₚ(g̅)=g̅ₑₚₓ|g̅ₑₓₚ∈g̅)=p and P(Ψₚ(g̅)=ϕ|g̅_{cxp}∈g̅)=1−p, p∈[0,1]. The FIG_{Δ} fidelity measure is well-behaved for all explanation functions in [symbol] .

Fid_{Δ} is well-behaved in a specific set of scenarios, where the task is deterministic and the classifier is completely explainable. However, it is not well-behaved in a wide range of scenarios of interest which do not have these properties. This is due to the OOD issue described above. To elaborate, for a good classifier, which has low probability of error, the distribution ƒ(G̅) should be close to [symbol] (·|\vec{G}) on average, i.e., [symbol] (d_{TV}(ƒ(G̅), P_{Y|G}(·|G̅)) should be small, where d_{TV} denotes the total variation.

As a result, \acute{P}(Y) is close to [symbol] (Y|G̅) on average. However, this is not necessarily true for the \acute{P}⁺(Y) and \acute{P}⁻(Y) terms. The reason is that the assumption [symbol] (d_{TV}(ƒ(G̅), [symbol] (·|G̅)))≈0 only ensures that ƒ(G̅) is close to [symbol] (·|G̅) for the typical realizations of G̅. However, G̅−Ψ(G̅) and Ψ(G̅) are not typical realizations. In many applications, it is very unlikely or impossible to observe the explanation graph in isolation, that is, to have G̅=Ψ(G̅). As a result, \acute{P}⁺(Y) and \acute{P}⁻(Y) are not good approximations for [symbol] (Y|G̅−Ψ(G̅)) and [symbol] (Y|Ψ(G̅)), respectively, and Fid₊, Fid₋, and Fid_{Δ} are not well-behaved.

Generally, in scenarios where Ψ(G̅) and G̅−Ψ(G̅) are not typical with respect to the distribution of G̅, the Fid_{Δ} measure may not be well-behaved. A class of modified fidelity measures may be used instead, by modifying the definitions of Fid₊ and Fid₋. To this end, the stochastic graph sampling function may be defined as E_{α}: G̅ [symbol] G̅_{α} with edge erasure probability α∈[0,1]. That is, E_{α}(·) takes a graph G̅ as input, and outputs a sampled graph G̅_{α} whose vertex set is the same as that of G̅, and its edges are sampled from G̅ such that each edge is included with probability α and erased with probability 1−α, independently of all other edges. The following generalized class of surrogate fidelity measures, and show that they are robust to OOD issues in wide range of scenarios:

$${Fid}_{{α}_{1} , +} {=}^{△} 𝔼 ( \hat{P} ( Y ) - {\hat{P}}^{{α}_{1} , +} ( Y ) ) , {Fid}_{{α}_{2} , -} {=}^{△} 𝔼 ( \hat{P} ( Y ) - {\hat{P}}^{{α}_{2} , -} ( Y ) ) , {Fid}_{{α}_{1} , {α}_{2} Δ} {=}^{△} {Fid}_{{α}_{1} , +} - {Fid}_{{α}_{2} , -} ,$$

where α₁, α₂∈[0,1], \acute{P}(·) is the distribution given by ƒ(G̅), \acute{P}^{α}^{₁}^{,+}(·) is the distribution given by ƒ(G̅−E_{α}_{₁}(Ψ(G̅))), and \acute{P}^{α}^{₂}^{,-}(·) is the distribution given by ƒ(E_{α}_{₂}(G̅−Ψ(G̅))+Ψ(G̅)).

The generalized fidelity measures can be empirically estimated by

$$, {=}^{△} \frac{1}{\vert \vert} {\sum }_{i = 1}^{\vert \vert} \frac{1}{\vert {\vert {ε}_{1} \vert}_{c}^{} ( {α}_{2} ) \vert} {\sum }_{{k}_{2} ∈ {ε}_{1 , {ε}_{1} \vert , {α}_{{2}^{, *}}}} {{\sum }_{ε ⊂ {ε}_{i} :}}_{{}_{\\}^{\\} \text{\textbar ε\textbar} = {k}_{2}} {\hat{P}}_{{ε}_{1}} ( {y}_{i} ) - {\hat{P}}_{ε ∪ {ε}_{e z p}} ( {y}_{i} ) {=}^{△} {}_{, +} - ,$$

where ϵ>0, [symbol] ∈ [symbol] , α, ϵ>0 denotes the interval { [symbol] (α−ϵ), [symbol] (α+ϵ)], the set [symbol] (α), [symbol] ∈ [symbol] , α∈[0,1], ϵ>0 is the set of ϵ-typical binary sequences of length [symbol] with respect to the Bernoulli [symbol] , α∈[0,1], ϵ>0 is the set of ϵ-typical binary sequences of length [symbol] with respect to the Bernoulli distribution with parameter α, i.e.,

$${ℓ}_{ℓ}^{} ( α ) {=}^{△} \{ {x}^{ℓ} ∈ {\{ 0 , 1 \}}^{ℓ} \vert \vert \frac{1}{ℓ} {Σ}_{i = 1}^{ℓ} 1 ( {x}_{i} = 1 ) - α \vert \leq ϵ \} ,$$

the distribution \acute{P}_{ε}(yᵢ) is the probability of yᵢ under the distribution ƒ(G̅_{ε}), where G̅_{ε} is the subgraph of G̅ with edge set restricted to ε, and [symbol] ={(G̅i, Yᵢ)|i∈[| [symbol] ||} is the set of observations, where εᵢ is the edge set of [symbol] ᵢ, i∈{ [symbol] ]. Using the Chernoff bound and standard information theoretic arguments, it can be shown that for fixed α₁, α₂ and

$$ϵ = O ( \sqrt{\frac{1}{\vert ε \vert}} ) ,$$

these empirical estimates converge to their statistical counterparts with rate of convergence

$$β = \frac{1}{2}$$

as | [symbol] |→∞ for large input graph and explanation sizes.

Fid_{α}_{₁}_{,α}_{₂}_{,Δ} is well-behaved for a general class of tasks and classifiers, where the original fidelity measure, Fid_{1,0,Δ} is not well-behaved. Specifically, it can be assumed that there exists set of set of motifs g̅_{y}, y∈ [symbol] , such that

$$P ( Y = y \vert \overline{G} = \overline{g} ) = \{ \begin{matrix}1 & if {\overline{y}}_{y} ⊆ \overline{g} and ∀ {y}^{′} \neq y : {\overline{g}}_{{y}^{′}} ⊈ \overline{g} \\ 0 & if ∃ \vert {y}^{′} \neq y : {\overline{g}}_{y} ⊈ \overline{G} , {\overline{g}}_{{y}^{′}} ⊆ \overline{G} \\ \frac{1}{\vert y \vert} & otherwise .\end{matrix}$$

Furthermore, given n∈ [symbol] and δ, ϵ∈[0,1], it can be assumed that the graph distribution P_{G} and the trained classifier ƒ_{δ}(·), satisfy the following conditions. The graph has n vertices. There exists a set [symbol] of classifier ƒ_{δ}(·), satisfy the following conditions. The graph has n vertices. There exists a set [symbol] of input graphs, called an ϵ-typical set, such that [symbol] ( [symbol] )>1−ϵ, and

$$P ( {f}_{δ} ( \overline{g} ) = {f}^{*} ( \overline{g} ) ) = {( \frac{1}{d ( , \overline{g} ) + 1} )}^{δ}$$

otherwise [symbol] ^{S}. The distance between the graph g̅ and the set of graphs [symbol] is defined as d( [symbol] , g̅) [symbol] [symbol] d(g̅′, g̅), and the distance between two graphs is defined as their number of edge differences.

In the classification scenario described above, the class of explanation functions [symbol] may include stochastic mappings Ψ: g̅ [symbol] Gₑₓₚ where P(G̅ₑₓₚ=g̅_{y}|G=g̅)=p for any g̅ such that ∃!y: g̅_{y}∈g̅ and G̅ₑₓₚ=ϕ. :g Gₑₓₚn otherwise. Then,

$${Fid}_{{α}_{1} , +} \geq {ϵ}^{*} - ϵ - \frac{P ( )}{1 - ϵ} ( ( 1 - p + p {max}_{y} {P}_{Y} ( y ) ) + 1 - {( \frac{1}{k + 1} )}^{δ} ) - P ( {c}^{} ) - 1 - P ( {′}^{} ) - ϵ {Fid}_{{a}_{2} , -} \leq {ϵ}^{*} - P ( ) ( 1 - {2}^{\frac{{k}^{2}}{2 {π}^{2}}} ) {( \frac{1}{k + 1} )}^{δ} p {Fid}_{{α}_{1} , {α}_{2} , Δ} \geq - ϵ - P ( ( {c}^{} ) - 1 - P ( {′}^{} ) \frac{P ( )}{1 - ϵ} ( ( 1 - p + p {max}_{y} {P}_{Y} ( y ) ) + 1 - {( \frac{1}{k + 1} )}^{δ} ) + P ( ) ( 1 - {2}^{\frac{{k}^{2}}{2 {n}^{2}}} ) {( \frac{1}{k + 1} )}^{δ} p$$

where ϵ* is the Bayes error rate,

$${α}_{1} {=}^{△} \frac{k}{2 {n}^{2}} , {α}_{2} {=}^{△} 1 - \frac{k}{2 {n}^{2}} , k < {s}_{1} {=}^{△} {min}_{y} \vert {\overline{y}}_{y} \vert .$$

[symbol]

is the event that ∃ly: g̅_{y}⊆G̅, and [symbol] ′ is the event that Σᵢ₌₁ⁿ^{²}Xᵢ>k, where Xᵢ are independent and identically distributed realizations of a Bernoulli variable with parameter α₁. Particularly, as k,n→∞ and δ, ϵ→0 such that k=o(n) and

$$δ = o ( \frac{1}{k} ) , \qquad {FIG}_{{α}_{{α}_{1} , {α}_{2} , Δ}}$$

becomes monotonically increasing in p. Consequently, there exists a non-zero error threshold ϵₜₕ>0, such that F_{id}d_{α}_{₁}_{,α}_{₂}_{,Δ} is well-behaved for all ϵ*≤ϵₜₕ. Atypical inputs in the training set may occur infrequently, which increases chance of misclassification for those inputs and hence gives rise to out-of-distribution issues.

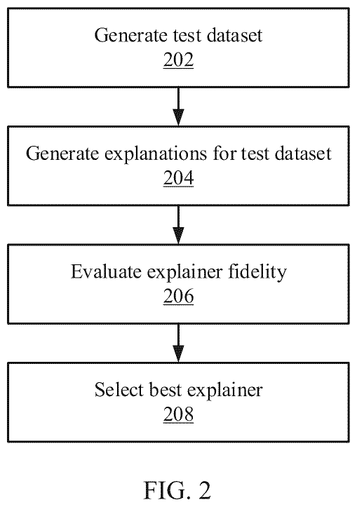

Referring now to FIG. 2, a method of selecting an explainer 108 is shown. Multiple different explainers may be available for use, including off-the-shelf explainer software and specially trained explainer models. The effectiveness of a given explainer may vary from one GNN task to another. Block 202 generates a test dataset for a particular task, using a representative set of inputs 102. Block 204 then uses the different available explainers to generate sub-graphs for the test dataset, for example creating competing sets of explanations.

Block 206 evaluates explainer fidelity as described above. A measure of fidelity is generated for each of the sets of explanations, corresponding to each of the respective explainers. A score may be generated for each explainer, for example by summing the fidelity scores for each example from each respective set or by averaging the fidelity scores for each example from each respective set. Block 208 then selects a best explainer, for example by taking the explainer with a highest corresponding score.

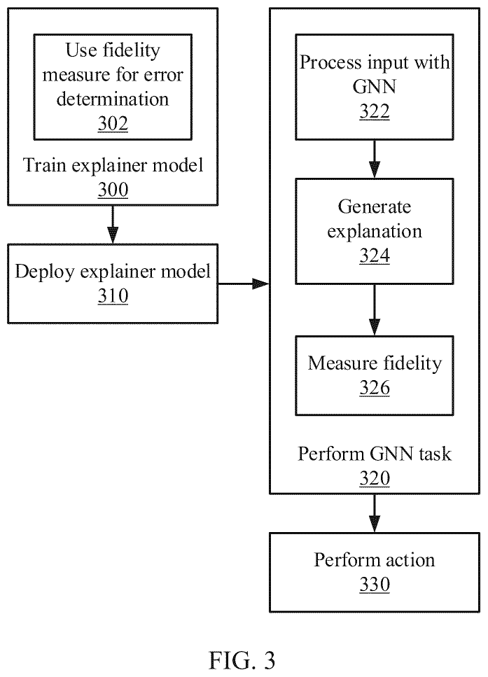

Referring now to FIG. 3, a method of training and using an explainer model is shown. The different steps of the method are separable and may be performed by different entities, or may be performed by a single entity. Block 300 trains an explainer model. This training 300 may use a training dataset that includes, for example, a set of graphs and a set of respective predetermined explanation sub-graphs. In some cases, the training 300 may fine-tune a pre-trained explainer model for a particular GNN task, using a set of task-specific input graphs. In either case, the fidelity measure may be used to compute error values for explanations generated by the explainer model during training in block 302. The error function may include the fidelity measure as part of an objective function that attempts to maximize fidelity.

Block 310 deploys the explainer model. In some cases, where the training 300 and the GNN task 320 are performed at the same location, the deployment 310 may be skipped. In other cases, parameters of the trained or fine-tuned explainer model may be transmitted to an inference site, where they will be used to aid in explaining the output of the GNN task 320.

Block 320 performs the GNN task, using any appropriate GNN model to process input graphs at block 322. Block 324 uses the trained explainer model to generate a sub-graph that explains the output of the GNN. Block 326 measures the fidelity of the sub-graph as described above, with explanation sub-graphs that produce outputs from the GNN which are similar to outputs from the corresponding original inputs producing higher fidelity scores.

Block 330 then performs an action based on the output of the GNN, the explanation sub-graph, and the fidelity measure. For example, the explanation sub-graph may be used to help guide the action to an appropriate location or to select the action that is to be performed. When the fidelity measure is high (e.g., above a fidelity threshold value), the action can be focused on a specific area indicated by the sub-graph. For example, in the event that the GNN indicates an intrusion in a computer network, the responsive action can target systems indicated by a sub-graph with a high fidelity measure. In contrast, a sub-graph with a low fidelity measure may not be trustworthy enough to rely on, and so the responsive action may need to have a broader target. In such an application, the action may include changing an operational state of one or more devices on the network (e.g., turning on or off routers or computers), changing a networking topology (e.g., changing a routing path between devices), and changing one or more security settings in the network devices (e.g., changing passwords, changing authentication types or stringency).

In some cases, the action of block 330 may relate to the selection of a pharmaceutical that is to have an intended effect in the human body. The GNN classifier 104 may indicate, for example, whether the a given molecule will bind with a particular protein related to a disease. The sub-graph 110 can help to explain how and why the molecule accomplishes that binding. In such an application, action of block 330 may include manufacturing the molecule so that it can be used in testing or therapies.

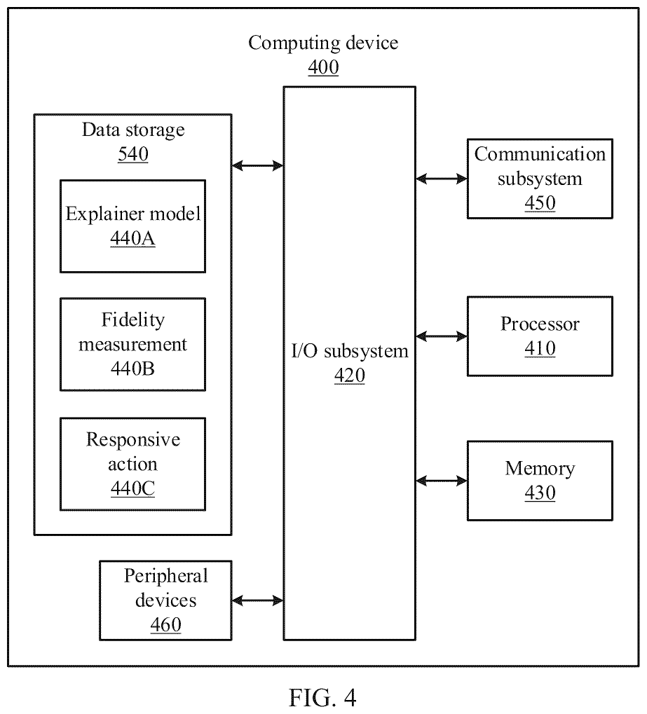

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for explaining a GNN's output, 440B for determining a fidelity measurement of an explanation sub-graph, and/or 440C for performing a responsive action. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

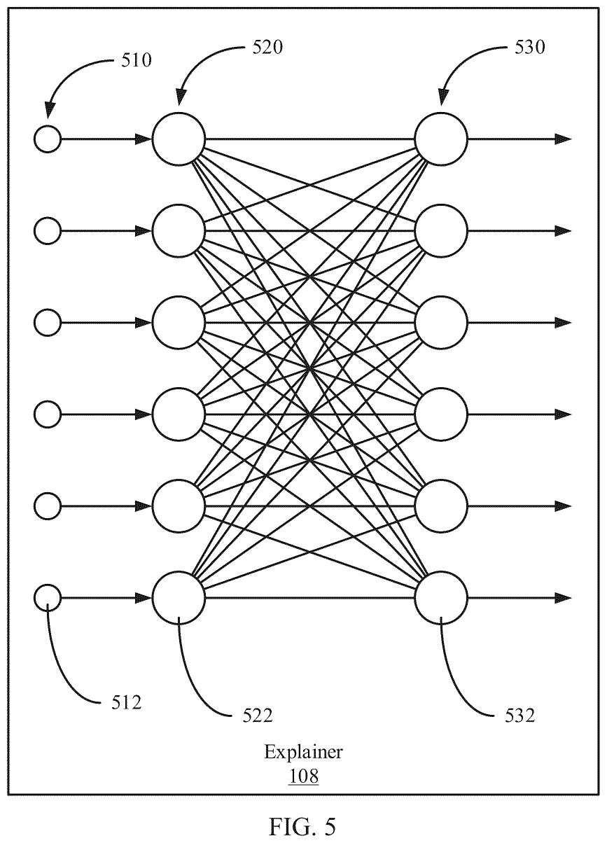

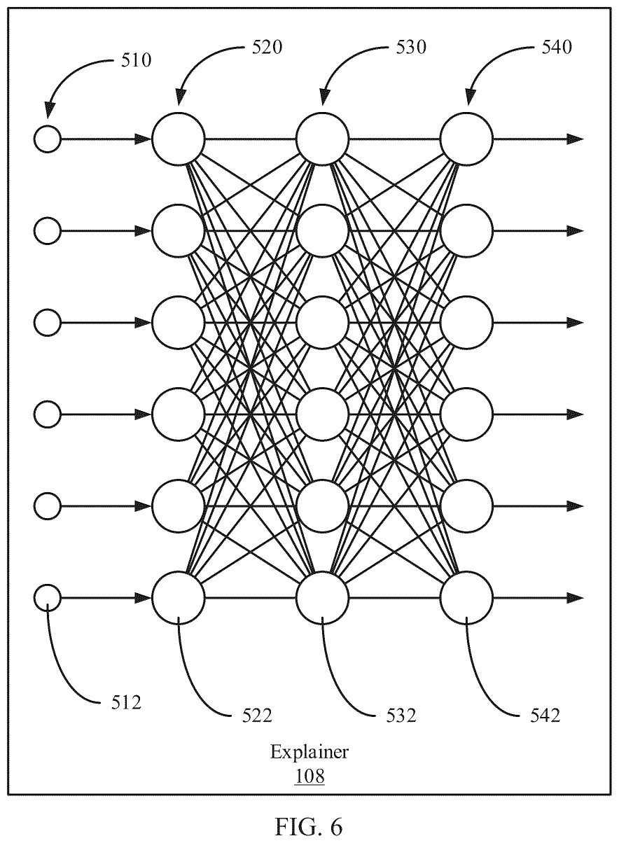

Referring now to FIGS. 5 and 6, exemplary neural network architectures are shown, which may be used to implement parts of the present models, such as the explainer 108. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention.

Having thus described aspects of the invention, with the details and particularity required by the patent laws, what is claimed and desired protected by Letters Patent is set forth in the appended claims:

1. A computer-implemented method, comprising:
processing an input graph using a graph neural network (GNN) to generate an output;
generating an explanation sub-graph using an explainer that identifies parts of the input graph that most influence the output;
determining a fidelity measure of the explanation sub-graph that is robust against distribution shifts; and
performing an action responsive to the output, the explanation sub-graph, and the fidelity measure.

2. The method of claim 1, further comprising selecting the fidelity measure based on fidelity scores generated across a test dataset.

3. The method of claim 2, wherein the fidelity measure is selected from a group of fidelity measures that include:
$${Fid}_{{α}_{1} , +} {=}^{△} 𝔼 ( \hat{P} ( Y ) - {\hat{P}}^{{α}_{1} , +} ( Y ) ) , {Fid}_{{α}_{2} , -} {=}^{△} 𝔼 ( \hat{P} ( Y ) - {\hat{P}}^{{α}_{2} , -} ( Y ) ) , {Fid}_{{α}_{1} , {α}_{2} , Δ} {=}^{△} {Fid}_{{α}_{1} , +} - {Fid}_{{α}_{2} , -} ,$$
where α₁, α₂∈[0,1], \acute{P}(·) is the distribution given by the GNN using the sub-graph, \acute{P}^{α}^{₁}^{,+}(·) is the distribution given by a first fidelity measure, \acute{P}^{α}^{₂}^{,-}(·) is the distribution given by a second fidelity measure, and Y is a graph class label.

4. The method of claim 2, wherein selecting the fidelity measure is based on an average of scores across the test dataset.

5. The method of claim 2, wherein selecting the fidelity measure is based on a sum of scores across the test dataset.

6. The method of claim 1, wherein the fidelity measure compares a behavior of the GNN using the sub-graph to a behavior of the GNN using the input graph.

7. The method of claim 1, wherein performing the action is performed responsive to a determination that a fidelity score output by the fidelity measure is above a fidelity threshold value.

8. The method of claim 1, wherein the action includes modifying a computer network responsive to a network intrusion indicated by the output, tailored to a portion of the network indicated by the sub-graph.

9. The method of claim 1, wherein the action includes manufacturing a molecule responsive to an efficacy indicated by the output.

10. The method of claim 1, further comprising training the explainer using the fidelity measure to determine error values.

11. A system, comprising:
a hardware processor; and
a memory that stores a computer program which, when executed by the hardware processor, causes the hardware processor to:
process an input graph using a graph neural network (GNN) to generate an output;
generate an explanation sub-graph using an explainer that identifies parts of the input graph that most influence the output;
determine a fidelity measure of the explanation sub-graph that is robust against distribution shifts; and
perform an action responsive to the output, the explanation sub-graph, and the fidelity measure.

12. The system of claim 11, wherein the computer program further causes the hardware processor to select the fidelity measure based on fidelity scores generated across a test dataset.

13. The system of claim 12, wherein the fidelity measure is selected from a group of fidelity measures that include:
$${Fid}_{{α}_{1} , +} {=}^{△} 𝔼 ( \hat{P} ( Y ) - {\hat{P}}^{{α}_{1} , +} ( Y ) ) , {Fid}_{{α}_{2} , -} {=}^{△} 𝔼 ( \hat{P} ( Y ) - {\hat{P}}^{{α}_{2} , -} ( Y ) ) , {Fid}_{{α}_{1} , {α}_{2} , Δ} {=}^{△} {Fid}_{{α}_{1} , +} - {Fid}_{{α}_{2} , -} ,$$
where α₁, α₂∈[0,1], \acute{P}(·) is the distribution given by the GNN using the sub-graph, \acute{P}^{α}^{₁}^{,+}(·) is the distribution given by a first fidelity measure, \acute{P}^{α}^{₂}^{,-}(·) is the distribution given by a second fidelity measure, and Y is a graph class label.

14. The system of claim 12, wherein the computer program further causes the hardware processor to select the fidelity measure based on an average of scores across the test dataset.

15. The system of claim 12, wherein the computer program further causes the hardware processor to select the fidelity measure based on a sum of scores across the test dataset.

16. The system of claim 11, wherein the fidelity measure compares a behavior of the GNN using the sub-graph to a behavior of the GNN using the input graph.

17. The system of claim 11, wherein the computer program further causes the hardware processor to perform the action responsive to a determination that a fidelity score output by the fidelity measure is above a fidelity threshold value.

18. The system of claim 11, wherein the action includes modifying a computer network responsive to a network intrusion indicated by the output, tailored to a portion of the network indicated by the sub-graph.

19. The system of claim 11, wherein the action includes manufacturing a molecule responsive to an efficacy indicated by the output.

20. The system of claim 11, wherein the computer program further causes the hardware processor to train the explainer using the fidelity measure to determine error values.
